(19) United States
(12) Patent Application Publication
(10) Pub. No.: US 2010/0095316 A1
(43) Pub. Date: Apr. 15, 2010

(54) CONTENT TRANSMISSION SERVER AND CLIENT AND METHOD

(76) Inventors: Kazunori IWABUCHI, Yokohama (JP); Kouji Kamogawa, Yokohama (JP); Yoshihiro Machida, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/421,005

(22) Filed: Apr. 9, 2009

(30) Foreign Application Priority Data
Aug. 12, 2008 (JP) 2008-207562

(51) Int. Cl. H04N 7/16; H04N 7/173

(52) U.S. Cl. 725/5; 725/116; 725/39; 725/28

(57) ABSTRACT

A content transmission server and client and method which may implement the viewing of contents by concentrating all the contents into the storage/delivery-performing server, and performing the television broadcast, and which may make unnecessary the video-recording at user's own whereabouts, and may prevent the unauthorized copy and leakage-out onto an unauthorized network by making the on-server video-recording always available in a manner of the on-server right purchasing.

This application relates to and claims priority from Japanese Patent Application No. 2008-207562 filed on Aug. 12, 2008, the entire disclosure of which is incorporated herein by reference.

### BACKGROUND OF THE INVENTION

1. Field of the Invention

The present invention relates to a television broadcast implemented via a network using Internet Protocol (IP), and a reception system therefore.

2. Description of the Related Art

More than 50 years have passed, since the television broadcasts using broadcasting airwaves were offered to the general public. Moreover, from the end of the 20th century over to the 21st century, discussions have been continuously made concerning a television broadcast which is implemented via a network, i.e., an amalgamation of the broadcasts and communications in the narrow sense. Under these backgrounds, considerations have been continuously given to the offer of the following television broadcast production/delivery system: Namely, in this system, a producer produces content such as a television broadcast or television program, then transferring the content to a server. Also, if there is an instruction from a user, the producer delivers the content thereto via an IP network. A mechanism for implementing a system like this is explained in, e.g., JP-A-2002-123634 as well.

### SUMMARY OF THE INVENTION

Conventionally, when a user received a television broadcast, the user found it possible to carry out its video-recording. An object of the present invention is to provide a function or service similar to this function or service in the IP-network-used television broadcast system as well.

There is provided a unit for viewing contents as being exactly described on an electronic program guide as if television broadcasts are watched, or for viewing and acquiring a program in the past or the future. This function implemented by this unit is made possible by collecting the contents into a storage/delivery server alone, and delivering the contents to an IP television from this storage/delivery server.

In the storage/delivery server, the broadcasting airwaves by electromagnetic waves are not received. Instead, the contents are directly inputted as the broadcasting data into the server, then being stored therein temporarily. This feature completely prevents an infringement of the right of a content-right holder, and permits a user to view the contents at any time (This is because all the contents exist in the server).

Other objects, features and advantages of the invention will become apparent from the following description of the embodiments of the invention taken in conjunction with the accompanying drawings.

### BRIEF DESCRIPTION OF THE DRAWINGS

FIG. 1 is an explanatory diagram for illustrating a television broadcast in the broadcast-communication amalgamation era;

FIG. 2 is an internal block diagram of a storage/delivery server and an IP television;

FIG. 3 is a functional block diagram of the storage/delivery server and the IP television;

FIG. 4 is an explanatory diagram for illustrating contents, a content management table, and a user management table;

FIG. 5 is an explanatory diagram for illustrating an electronic program guide of A channel;

FIG. 6 is an explanatory diagram for illustrating in-advance viewing of a future program;

FIG. 7 is an explanatory diagram for illustrating in-advance purchase of a future program;

FIG. 8 is an explanatory diagram for illustrating reservation video-recording of a future program;

FIG. 9 is an explanatory diagram for illustrating the reservation video-recording operation;

FIG. 10 is an explanatory diagram for illustrating a deadline condition for accepting the reservation video-recording;

FIG. 11 is an explanatory diagram for illustrating a reproduction operation;

FIG. 12 is an explanatory diagram for illustrating an ordinary broadcast;

FIG. 13 is an explanatory diagram for illustrating a storage;

FIG. 14 is an explanatory diagram for illustrating the viewing start time-and-date, viewing termination time-and-date, and a processing flow for the viewing right;

FIG. 15 is an explanatory diagram for illustrating the relationship between content and a play list; and

FIG. 16 is an explanatory diagram for illustrating the relationship between content and the content management table.

### DESCRIPTION OF THE INVENTION

It is preferable that the storage/delivery server be constructed in a data center where infrastructures such as power-supply and air-conditioning are well-equipped, and into/from which the enter/leave by people is limited, and which is connected to a high-speed network. Also, it is effective enough that the IP television for receiving image information delivered from the storage/delivery server be of an appliance form like an already-existing home-use-oriented television. No particular appliance form, however, is specified here. This is because the television function has been already integrated into various products, such as mobile telephone, digital tuner, DVD recorder, and personal computer.

### Embodiment 1

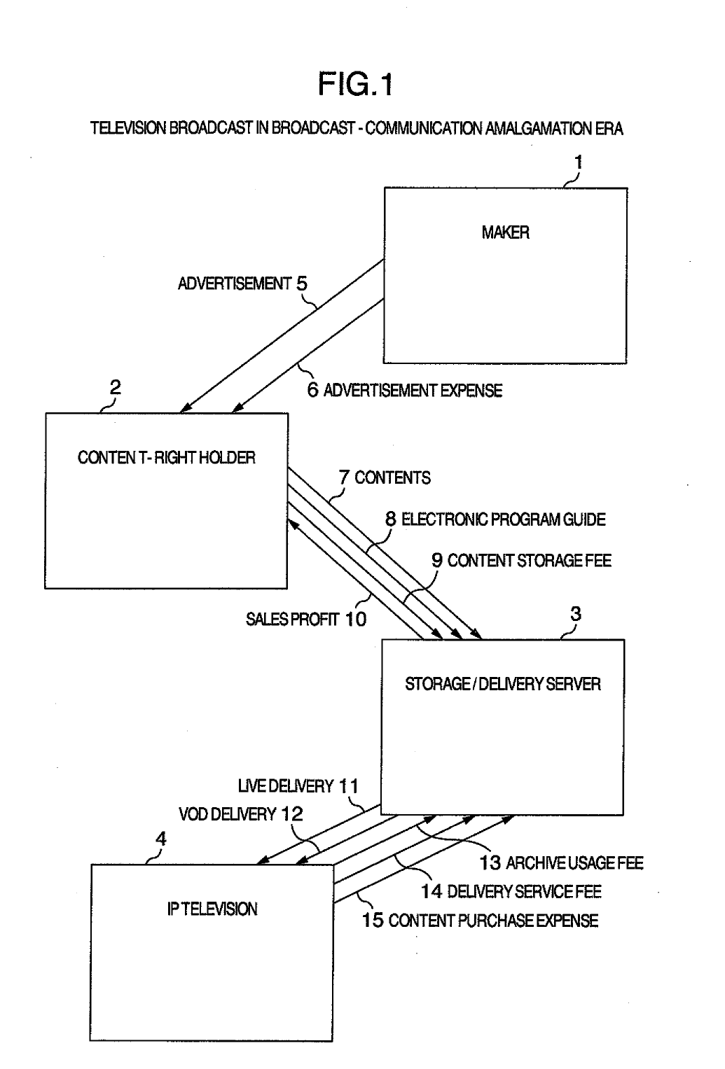

FIG. 1 is an explanatory diagram for illustrating a television broadcast in the broadcast-communication amalgamation era. The reference numerals denote the following components and functions, respectively: 1 maker, 2 content-right holder, 3 storage/delivery server, 4 IP television, 5 advertisement, 6 advertisement expense, 7 contents, 8 electronic program guide, 9 content storage fee, 10 sales profit, 11 live delivery, 12 VOD delivery, 13 archive usage fee, 14 delivery service fee, and 15 content purchase expense.

Hereinafter, the explanation will be given below concerning the mechanism of the television broadcast system in the broadcast-communication amalgamation era illustrated in FIG. 1. The maker 1, which wishes to place the advertisement 5 onto the television broadcast, requests the content-right holder 2 to place the advertisement 5 by paying the advertisement expense 6 to the content-right holder 2. The content-right holder 2 produces the program, then sending, as the contents 7, the contents 7 and the accompanying electronic program guide 8 to the storage/delivery server 3. At this time, the content-right holder 2 pays the content storage fee 9 to the storage/delivery server 3.

Using the contents 7 that the storage/delivery server 3 has received, the server 3 carries out the live delivery 11 or the VOD (Video On Demand) delivery 12 to the IP television 4, thereby embodying the present television broadcast. A (not-illustrated) user, who is watching the IP television 4, pays the delivery service fee 14 and the archive usage fee 13 or the content purchase expense 15 to an enterprise which manages the storage/delivery server 3. The storage/delivery server 3 distributes the profit to the content-right holder 2 as the sales profit 10 for the contents 7.

Here, the storage/delivery server 3 receives the content storage fee 9 from the content-right holder 2, and receives the archive usage fee 13 from the user of the IP television 4, respectively. As a result, the storage/delivery server 3 may manage to raise an operation expense for the storage/delivery, thereby permitting the present television broadcast service to be continued as a business. In this point, the present television broadcast service differs from the already-existing television broadcast system. In the already-existing television broadcast system, the so-called broadcast station exists at the position of the storage/delivery server 3. Nothing, however, is carried out concerning the reception of the content storage fee 9 and the reception of the archive usage fee 13.

The reason for this is that the already-existing television broadcast has become a broadcast which is designed for only the very point-in-time when the broadcast is actually performed, i.e., the already-existing television broadcast has not become the system which stores the contents and permits the user of the IP television 4 to view the contents at any time. In other words, since the contents are stored into the storage/delivery server 3, the user of the IP television 4 may view the contents at any time. In substitution therefore, the user pays the archive usage fee 13 and the content purchase expense 15. Accordingly, the content-right holder 2 may receive the new sales profit 10.

Also, as is the case with the already-existing television broadcast system, the content-right holder 2 receives the advertisement expense 6. As a result, the payment of the delivery service fee 14 by the user, in fact, has become free of charge. Similarly, if the amount of money of the advertisement expense 6 or the one of the sales profit 10 is adjusted, this payment becomes implementable as a service in the present television broadcast system as well.

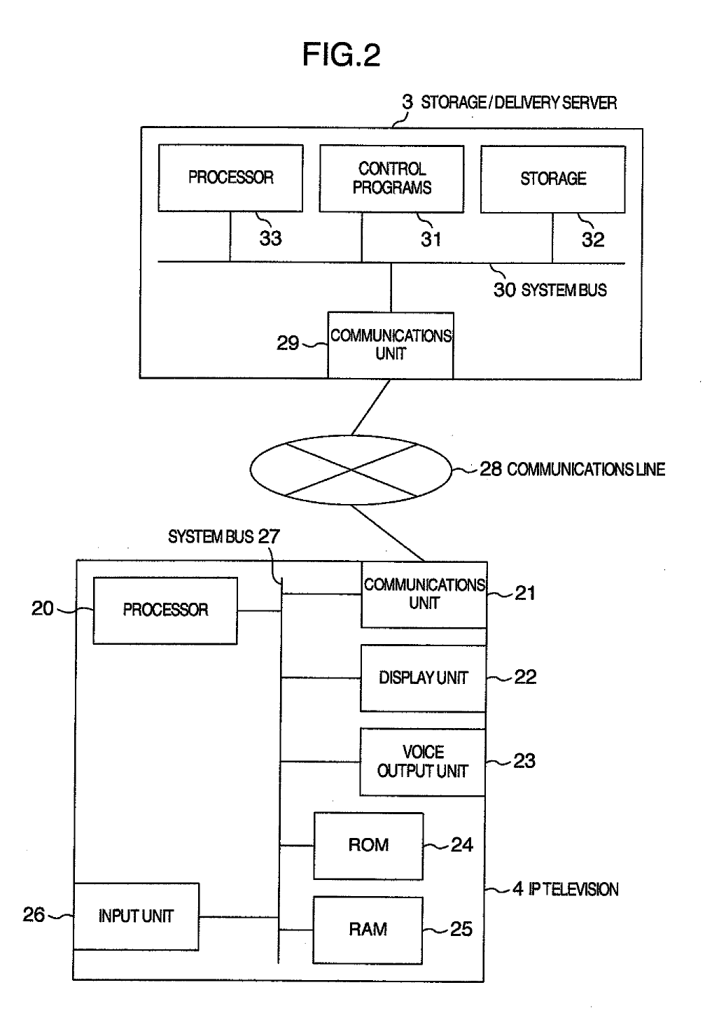

FIG. 2 is an internal block diagram of the storage/delivery server 3 and the IP television 4. The reference numerals denote the following components, respectively: 20 processor, 21 communications unit, 22 display unit, 23 voice output unit, 24 ROM, 25 RAM, 26 input unit, 27 system bus, 28 communications line, 29 communications unit, 30 system bus, 31 control programs, 32 storage, and 33 processor.

The storage/delivery server 3 and the IP television 4 are subsystems which are controlled by the processor 33 and the processor 20, respectively. In addition to the above-described processor 33, the components existing inside the storage/delivery server 3 are the control programs 31, the storage 32, and the communications unit 29 which are connected to the system bus 30. The processor 33 executes the control programs 31, thereby delivering the (not-illustrated) contents stored into the storage 32 to the communications line 28 via the communications unit 29.

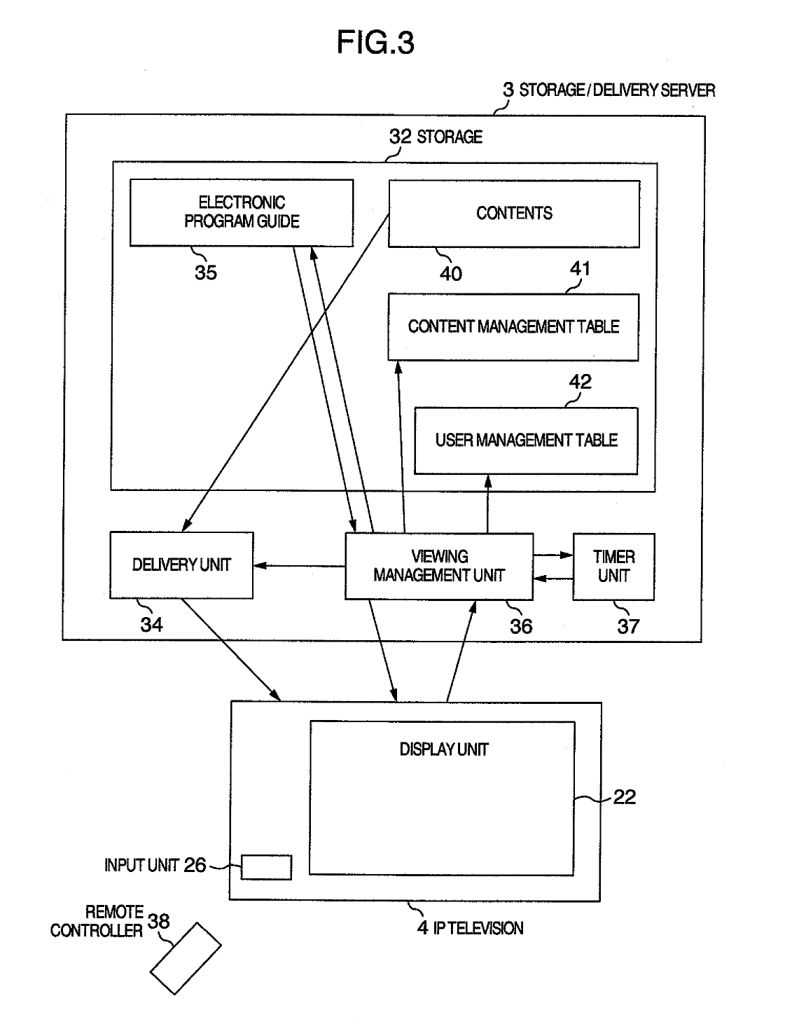

In addition to the above-described processor 20, the components existing inside the IP television 4 are the communications unit 21, the display unit 22, the voice output unit 23, the ROM 24, the RAM 25, and the input unit 26 which are connected to the system bus 27. The processor 20 runs a (not-illustrated) control program which is stored into the ROM 24. Next, the processor 20 receives an instruction from the user (operation using a remote controller is assumed, and the remote controller is illustrated in FIG. 3 which will be given next) from the input unit 26. Moreover, the processor 20 outputs the contents, which are received from the storage/delivery server 3 via the communications unit 21, as the corresponding images and voices through the display unit 22 and the voice output unit 23. Here, the RAM 25 is used as a temporary information storage unit in the control program stored into the ROM 24.

Based on the above-described operation, the contents delivered from the storage/delivery server 3 may arrive at the IP television 4 via the communications line 28. As a consequence, the so-called viewing of a television program may be provided to the user.

FIG. 3 is a functional block diagram of the storage/delivery server 3 and the IP television 4. In FIG. 2, the physical component configuration has been illustrated. In FIG. 3, however, the explanation will be given regarding logical functions of the storage/delivery server 3 and the outer appearance of the IP television 4.

In FIG. 3, the reference numerals denote the following logical functions, respectively: 34 delivery unit, 35 electronic program guide, 36 viewing management unit, 37 timer unit, 38 remote controller, 40 contents, 41 content management table, and 42 user management table.

The outer appearance of the IP television 4 is the display unit 22 which the user can watch. The remote controller 38 transmits an operation of the IP television 4 by the user via the input unit 26. The functions existing inside the storage/delivery server 3 are the viewing management unit 36, the timer unit 37, and the delivery unit 34. The functions stored inside the storage 32 are the content 40, the content management table 41, the user management table 42, and the electronic program guide 35.

The control information, which is given by the operation of the remote controller 38 by the user, and which is sent to the storage/delivery server 3, is further sent to the viewing management unit 36 inside the storage/delivery server 3. The IP television 4 receives response information to the control information from the viewing management unit 36 similarly. Also, image/voice information on the content 40 is delivered from the delivery unit 34, then being sent to the IP television 4.

The respective types of functions such as the delivery unit 34, the viewing management unit 36, and the timer unit 37 are implemented by the processor 33's executing the control programs 31 such as a delivery program, viewing management program, and timer program. Also, these functions may be implemented using not the programs but hardware, such that, e.g., the integrated-circuit implementation of these functions is achieved as processing units for performing the respective processings such as the delivery unit 34, the viewing management unit 36, and the timer unit 37.

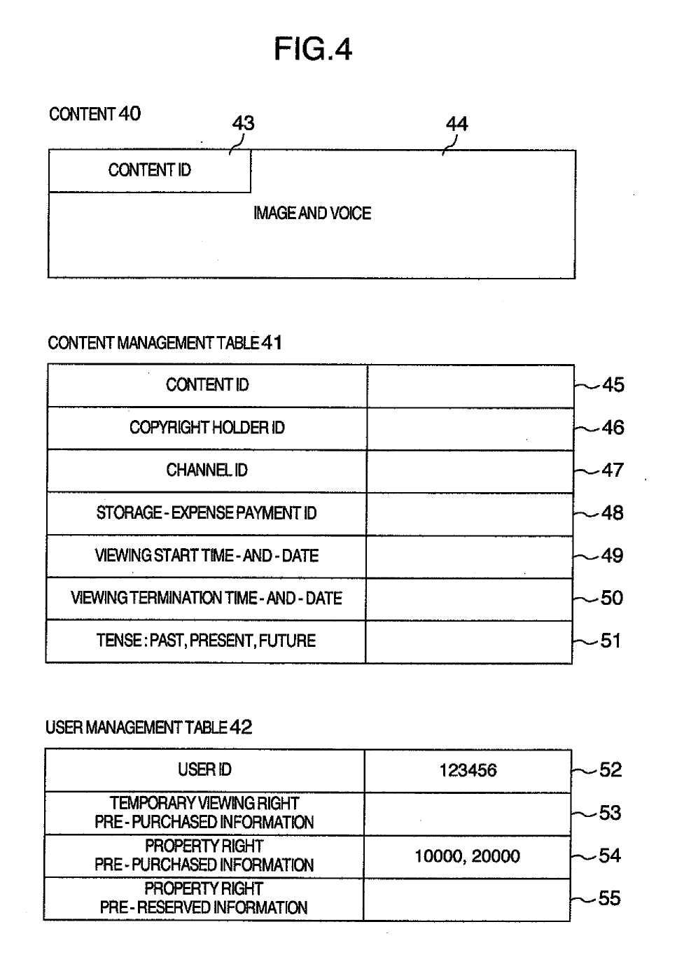

FIG. 4 is an explanatory diagram for illustrating internal information on the content 40, the content management table 41, and the user management table 42 which are stored into the storage 32 inside the storage/delivery server 3 in FIG. 3. Here, the reference numerals denote the following information, respectively: 43 content ID, 44 image and voice, 45 content ID, 46 copyright holder ID, 47 channel ID, 48 storage-expense payment ID, 49 viewing start time-and-date, 50 viewing termination time-and-date, 51 tense, 52 user ID, 53 temporary viewing right pre-purchased information, 54 property right pre-purchased information, and 55 property right pre-reserved information.

The content 40 indicates the inside of each of a plurality of contents which exist. Each content 40 possesses a format in which the content ID 43, i.e., a unique ID number, is allocated to the image and voice 44 inside the storage/delivery server 3. Since the content ID 43 is unique, the pluralities of existing contents are in a state where each content is distinguishable.

The content management table 41 is a table which includes thereon the information from the content ID 45 to the tense 51, and which exists in such a manner that the table 41 is kept in a pair with each content 40. On account of this, the head region of the content management table 41 stores therein the content ID 45 which is connected to the content ID 43 of the corresponding content 40 on a one-to-one basis.

The copyright holder ID 46 is an ID number which is uniquely allocated to each content-right holder 2 in FIG. 1, and which indicates the copyright holder of each content 40. The channel ID 47 is an ID number for indicating on which channel (broadcast station) this content should be broadcasted (delivered). This is basically the same as what is referred to as “the channel of a broadcast station” in the already-existing television broadcast. The storage-expense payment ID 48 is an ID number for indicating on whose storage-expense payment the corresponding content 40 should be stored in the storage/delivery server 3. The same ID number as the copyright holder ID 46 is usually stored.

Incidentally, if the copyright holder, i.e., the content-right holder 2 in FIG. 1 disclaims the copyright for some reason or other, the storage-expense payment ID 48 is initiated. As a result, an enterprise which manages the storage/delivery server 3 is required to pay the storage expense.

The viewing start time-and-date 49 indicates from when the corresponding content 40 may be able to be viewed. This is information equivalent to the broadcast start point-in-time in the already-existing television broadcast system. As the viewing termination time-and-date 50, broadcast termination point-in-time of the corresponding content 40 may also be specified. However, when, e.g., the broadcast right vanishes three months after the broadcast start, the viewing-capable time-period may be pointed out by describing this three months into the viewing termination time-and-date 50.

As a consequence, when the viewing termination time-and-date 50 has expired, there exists an effect of becoming capable of imposing a limitation that the user may not purchase or view this content afterwards. The tense 51, which describes therein a flag for past, present, or future, indicates whether the corresponding content 40 is a past program, or a present program which is being broadcasted at present, or a future program which has not been broadcasted yet.

When the channel 0 whose ID is all “0”s is specified into the channel ID 47, this content is dealt with not as the broadcast-intended content, but as something like commercially-available package software. In this case, the content managed in the content management table 41 will never be broadcasted, but becomes a service where its property right may be on sale when the content is purchased by the user.

As having been explained so far, the content management table 41 stores therein the important information associated with the viewing of the corresponding content 40.

The user management table 42 is a management table which is created for each user of the IP television 4 illustrated in FIG. 3. The table 42 stores therein the information on the user ID52, the temporary viewing right pre-purchased information 53, the property right pre-purchased information 54, and the property right pre-reserved information 55. The user ID52 is allocated to each user of the IP television 4 as a unique ID number inside the storage/delivery server 3. The user ID52 is written at a specified position in the user management table 42.

The user ID52 in the user management table 42 illustrated in FIG. 4 stores therein a numerical figure of “123456” at present. This numerical figure indicates that the table 42 is the user management table of the user that has the ID number of “123456”.

Also, the temporary viewing right pre-purchased information 53, the property right pre-purchased information 54, and the property right pre-reserved information 55 stores therein the information on the viewing and property granted to the user of the IP television 4. Concretely, the 0 or more content IDs 43 is or are described. In FIG. 4, the property right pre-purchased information 54 stores therein a numerical figure of “10000” and a numerical figure of “20000”.

Since these numerical figures indicate the content IDs 43, these figures mean that the user owns the two contents whose content IDs 43 are “10000” and “20000” respectively. When the user owns the content, the user of the IP television 4 is required to pay the archive usage fee 13 illustrated in FIG. 1. Namely, if the content ID is recorded into the property right pre-purchased information 54 in the user management table 42, the viewing management unit 36 accepts collection of the content storage fee from the user terminal.

Incidentally, the property right pre-purchased information stores therein not the contents themselves, i.e., real entities, but the meaning of simply owning the contents. Accordingly, it is conceivable that the archive usage fee 13 should usually be of a service form of being not so expensive. Concerning concrete usage methods for the temporary viewing right pre-purchased information 53, the property right pre-purchased information 54, and the property right pre-reserved information 55, the brief description will be given in the following explanation of the embodiments.

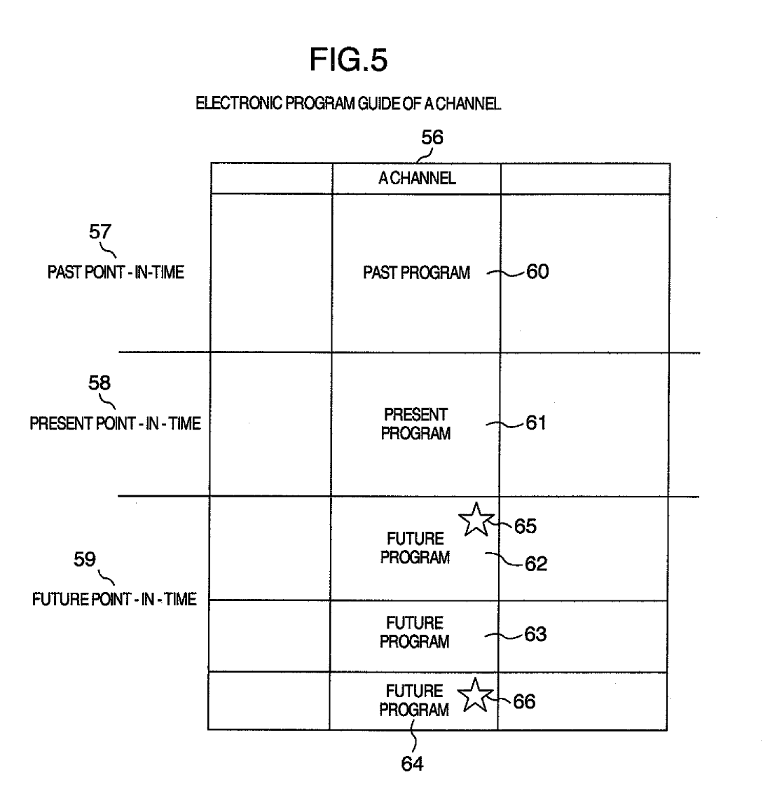

FIG. 5 is an explanatory diagram for illustrating the electronic program guide of A channel. Here, the reference numerals denote the following information, respectively: 56 the A channel, 57 past point-in-time, 58 present point-in-time, 59 future point-in-time, 60 past program, 61 present program, 62, 63, 64 future programs, and 65 and 66 asterisks. The A channel, which is a figure of speech, is a state where the channel ID47 of the content management table 41 illustrated in FIG. 4 has become the ID number for indicating the A channel.

The electronic program guide 8 illustrated in FIG. 1 given earlier has been explained such that it is provided by the content-right holder 2. Also, in FIG. 3, the electronic program guide has been the electronic program listing 35 which lies in the state of being stored inside the storage 32 of the storage/delivery server 3. In FIG. 5, the electronic program guide, as the electronic program listing of the A channel, displays each program (content) with time deployed along the longitudinal axis. Here, the electronic program guide corresponds to the state in FIG. 3 where the electronic program guide is sent to the IP television 4 by the viewing management unit 36, and is displayed by the display unit 22.

In FIG. 5, the present program 61 is displayed at the position of the present point-in-time 58. Also, the past program 60 is displayed at the position of the past point-in-time 57. Also, the three future programs starting from the future program 62 are displayed at the position of the future point-in-time 59. In this way, the electronic program guide is a list for displaying programs which are broadcasted on a certain specific channel. Here, however, the asterisks 65 and 66 are displayed in a manner of being affixed to the future programs 62 and 64 respectively, but no asterisk is displayed with respect to the future program 63.

These asterisks 65 and 66 indicate that the future programs 62 and 64 with the asterisks 65 and 66 lie in the state of having been sent as the contents 7 from the content-right holder 2 to the storage/delivery server 3 in FIG. 1. Consequently, when seen from the present point-in-time 58 that the broadcast schedule time is approaching, the future program 62, i.e., the next program, has already arrived at the storage/delivery server 3, but the future program 63 has not yet arrived thereat.

Also, the future program 64 is meant to have been produced and recorded already, or to have already arrived at the storage/delivery server 3. In FIG. 5, it is indicated using the asterisks whether or not the future programs have already arrived thereat. A display method other than the asterisks, however, is also available.

Incidentally, if the channel ID 47 is “0”, the content is a sales-target content. Accordingly, this content is not displayed on this electronic program guide. However, an embodiment is conceivable where the storage/delivery server 3 is separately equipped with a function for displaying the content as one of a list of sales-target contents.

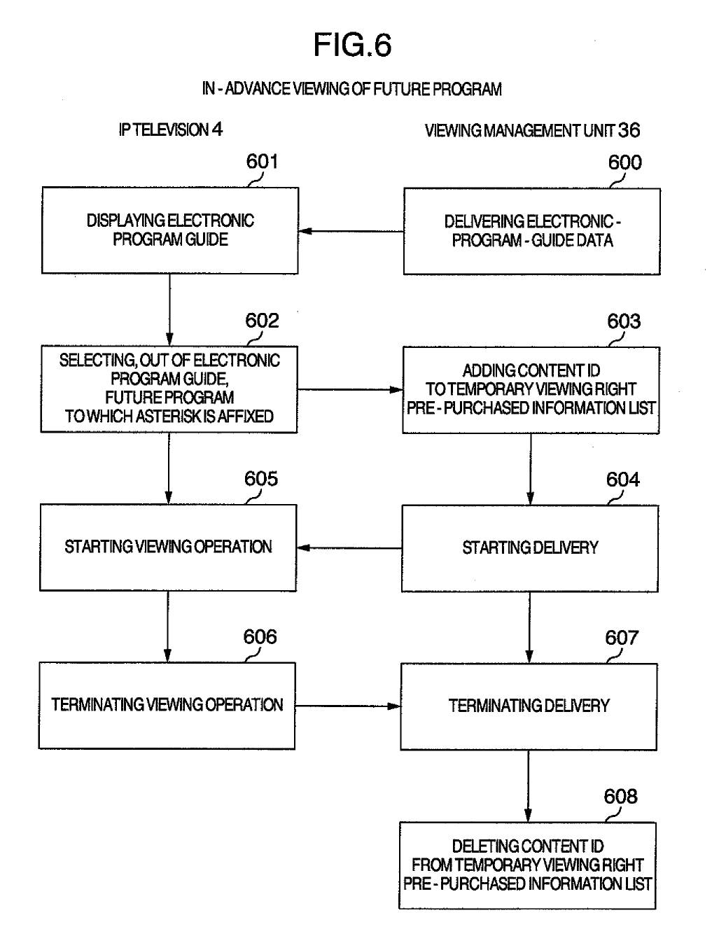

FIG. 6 is an explanatory diagram for illustrating a service of the in-advance viewing of a future program. Using sequence numbers starting from 600 in FIG. 6, the explanation will be given below concerning the sequences of the in-advance viewing of a future program in the IP television 4 and the viewing management unit 36 inside the storage/delivery server 3. First, at 600, electronic-program-guide data is delivered from the viewing management unit 36 to the IP television 4.

At 601, the IP television 4 displays the electronic program guide. This is the electronic program guide whose explanation on the display has been given using FIG. 5. At 602, the user of the IP television 4 selects, out of the electronic program guide, a future program to which the asterisk is affixed. This is the content (program) which, in FIG. 5, is explained to have already arrived at the storage/delivery server 3.

At 603, in order to address the future program selected, the viewing management unit 36 adds and describes the content ID of the future program into the region of the temporary viewing right pre-purchased information 53 in the user management table 42 illustrated in FIG. 4. After that, at 604, the viewing management unit 36 starts the delivery of the future program having the content ID. Having received the content, the IP television 4 starts the viewing operation at 605. As a result, the motion picture is displayed on the display unit 22 of the IP television 4 in FIG. 3. When the viewing operation is terminated, the IP television 4 is transitioned to 606. In the viewing management unit 36, the delivery is terminated at 607. After that, since the viewing is terminated, the viewing management unit 36 deletes the content ID from the region of the temporary viewing right pre-purchased information 53 in the user management table 42 illustrated in FIG. 4.

As a consequence of the above-described operation, even in the case of a future program which has not been broadcasted yet, the future program has already arrived at and has been stored into the storage/delivery server 3. Accordingly, the user of the IP television 4 may view the future program. Incidentally, although no explanation has been given, it is needless to say that, because of the future program, the user of the IP television 4 is required to pay the delivery service fee 14 and the content purchase expense 15. In the present embodiment, unlike the already-existing television broadcast, there exists an effect of permitting the user to view even a future program.

Also, although no explanation has been given, even in the case of a past or present program, the corresponding content has already been stored into the storage/delivery server 3. Consequently, the user may perform the viewing operation. Namely, even in the case of a program which has already been broadcasted, the user may view the program afterwards.

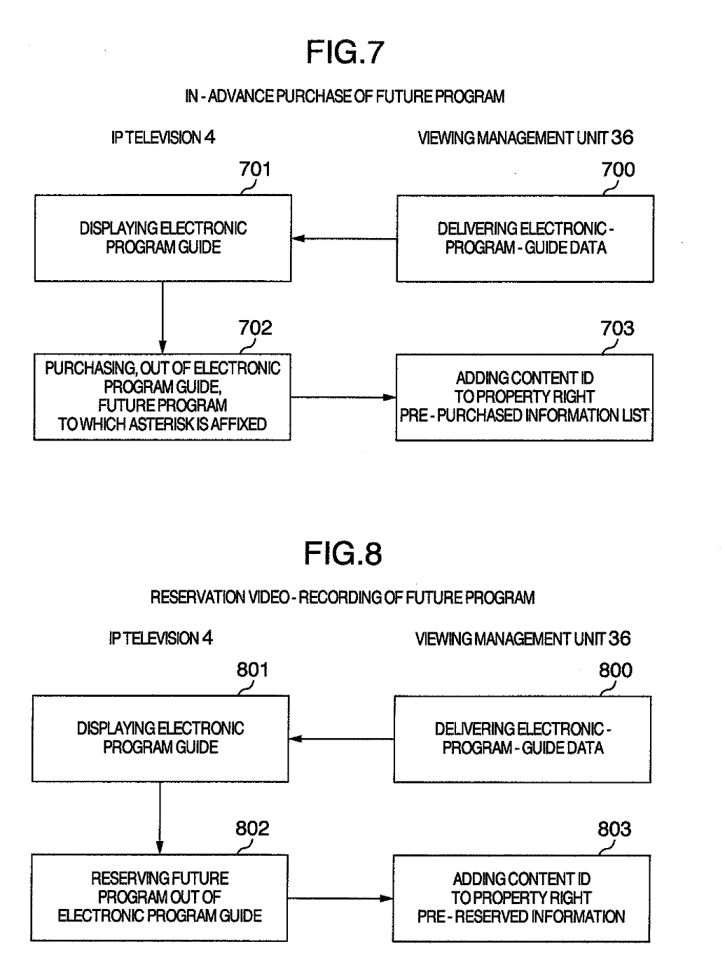

FIG. 7 is an explanatory diagram for illustrating a service of the in-advance purchase of a future program. Using sequence numbers starting from 700 in FIG. 7, the explanation will be given below concerning the sequences of the in-advance purchase of a future program in the IP television 4 and the viewing management unit 36 inside the storage/delivery server 3. First, at 700, electronic-program-guide data is delivered. At 701, the IP television 4 displays the electronic program guide.

At 702, the user of the IP television 4 performs, out of the electronic program guide, a purchase instruction for a future program to which the asterisk is affixed. Then, at 703, the viewing management unit 36 adds and describes the content ID of the future program into the region of the property right pre-purchased information 54 in the user management table 42 illustrated in FIG. 4. As a consequence of the above-described operation, even in the case of a future program which has not been broadcasted yet, the user may purchase the future program, and acquire its property right. It turns out that this service becomes close to a service of purchasing package software like DVD.

Also, although no explanation has been given, even in the case of a past or present program which is being broadcasted at present, the corresponding content has already been stored into the storage/delivery server 3. Consequently, the user may perform the purchase operation. Incidentally, it is needless to say that the content purchase expense 15 in FIG. 1 becomes necessary at the purchase operation in whatever cases.

FIG. 8 is an explanatory diagram for illustrating a service of the reservation video-recording of a future program. Using sequence numbers starting from 800 in FIG. 8, the explanation will be given below concerning the sequences of the reservation video-recording of a future program in the IP television 4 and the viewing management unit 36 inside the storage/delivery server 3. First, at 800, electronic-program-guide data is delivered. At 801, the IP television 4 displays the electronic program guide.

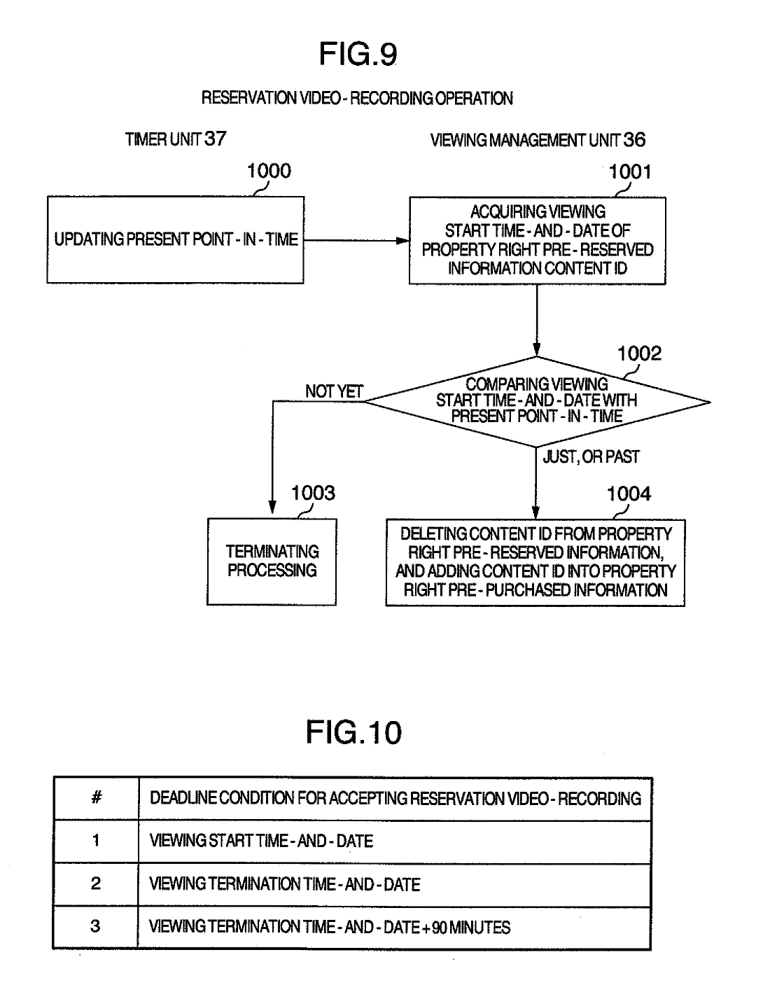

Next, at 802, the user of the IP television 4 performs a reservation instruction for a future program out of the electronic program guide. At this rime, unlike the above-described embodiment, the presence or absence of the asterisk is of no importance. Then, at 803, the viewing management unit 36 adds and describes the content ID of the future program into the region of the property right pre-reserved information 55 in the user management table 42 illustrated in FIG. 4. As a consequence of the above-described operation, the reservation video-recording will be carried out. Using FIG. 9, the explanation will be given below regarding its embodiment.

FIG. 9 is an explanatory diagram for illustrating the reservation video-recording operation. In FIG. 8 given earlier, the reservation instruction for the future program has already been performed. Using sequence numbers starting from 1000 in FIG. 9, the explanation will be given below concerning the reservation video-recording processing. First, at 1000, the timer unit 37 inside the storage/delivery server 3 updates the present point-in-time. At 1001, the viewing management unit 36 reads the region of the property right pre-reserved information 55 in the user management table 42 illustrated in FIG. 4, thereby acquiring the content ID. Next, the viewing management unit 36 acquires the viewing start time-and-date 49 for each content management table 41.

Moreover, at 1002, the viewing management unit 36 makes a comparison between the viewing start time-and-date 49 and the present point-in-time notified from the timer unit 37. Then, if the present point-in-time has not attained to the viewing start time-and-date 49 yet, the unit 36 proceeds to 1003, then terminating the processing. Meanwhile, if, at 1002, the present point-in-time just coincides with or is past the viewing start time-and-date 49, the unit 36 proceeds to 1004. Next, the unit 36 deletes the content ID from the region of the property right pre-reserved information 55, then adding and describing the content ID into the region of the property right pre-purchased information 54.

As a consequence of the above-described operation, the future program whose reservation video-recording operation was instructed becomes a program whose property right has been pre-purchased. Incidentally, although no explanation has been given, it is needless to say that all the users' user management tables 42 managed by the storage/delivery server 3 should be processed.

In the present embodiment, it is conceivable that the reservation video-recording, originally, is a video which can be owned when time has elapsed and a future program is broadcasted. In the storage/delivery server 3, however, the processing is terminated by merely transitioning the description from the property right pre-reserved information to the property right pre-purchased information. Namely, the content itself is not actually copied. Accordingly, the user may implement the reservation video-recording operation remarkably easily.

Also, in the present embodiment, its feature lies in the mechanism that the processing for transferring the property right is awaited until the program is broadcasted. This mechanism permits implementation of completely the same state as the state that, in the already-existing television broadcast system, the video-recording into a video-recording device can generally be carried out free of charge as a deed of creating a private duplicate. Consequently, this operation is carried out free of charge in the present embodiment. As a result, there exists an effect that the user of the IP television 4 is not required to pay the expense for purchasing the content.

Also, the contents are stored in the storage/delivery server 3 at any time by preparing the broadcast-time-and-date-conscious mechanism. As a result, there exists an effect that it may become possible to break the user's behavior psychology that he or she must view or video-record content in a hurried and panicky manner.

FIG. 10 is an explanatory diagram for illustrating other examples of ways-of-thinking of the point-in-time at which the viewing management unit 36 accepts the reservation video-recording by the user operation in the reservation video-recording explained in FIG. 8 and FIG. 9. The general concept of the reservation video-recording is that the video-recording is reserved before the broadcast of a program is started. In the present embodiment, however, content which becomes the video-recording target has already been stored into the storage/delivery server 3. Accordingly, there exist embodiments where different ways-of-thinking are implemented. By the way, in the flow for the reservation video-recording operation in FIG. 9, the viewing start time-and-date of the property right pre-reserved information content ID has been acquired at 1001, and the comparison with the present point-in-time has been made at 1002.

In FIG. 10, this flow is considered as being a deadline condition based on which the viewing management unit 36 accepts the reservation video-recording by the user operation. This consideration leads to a condition that, like #1 in FIG. 10, the reservation video-recording is accepted as long as the present point-in-time is before the viewing start time-and-date. As another example, like #2 in FIG. 10, the viewing termination time-and-date is considered as being the deadline. Namely, at 1002 in FIG. 9, the viewing termination time-and-date is acquired instead of the viewing start time-and-date, then operating the reservation video-recording. This consideration leads to the following condition: While the program is being broadcasted, i.e., the broadcast is started from the viewing start time-and-date 49 in the content management table 41, and, if the present point-in-time is before the point-in-time at which the broadcast of the program is terminated, the video-recording is addressed as the reservation video-recording.

According to this way-of-thinking, as long as the user is in time for the termination point-in-time of the program even if he or she is not in time for the broadcast start point-in-time thereof, the user may perform and implement the free-of-charge video-recording explained in FIG. 9. Also, #3 in FIG. 10 indicates the following still another way-of-thinking: As the deadline condition based on which the viewing management unit 36 accepts the reservation video-recording by the user operation, the reservation video-recording is accepted as long as the present point-in-time falls within 90 minutes after the broadcast of the program had been terminated.

Concretely, this way-of-thinking leads to the following condition: At 1002 in FIG. 9, the time-and-date obtained by adding 90 minutes to the very numerical value of the viewing start time-and-date itself is used instead of the very numerical value of the viewing start time-and-date itself. In a digital broadcast, there exists a scheme where a time shift within 90 minutes is recognizable. This way-of-thinking implements this scheme. According to this way-of-thinking, even if the broadcast of the program had been terminated, the user may perform and implement the video-recording as long as the present point-in-time falls within 90 minutes after the termination point-in-time. As a result, there exists an effect that the user is liberated from a situation that the user must return in a hurried and panicky manner when he or she goes out.

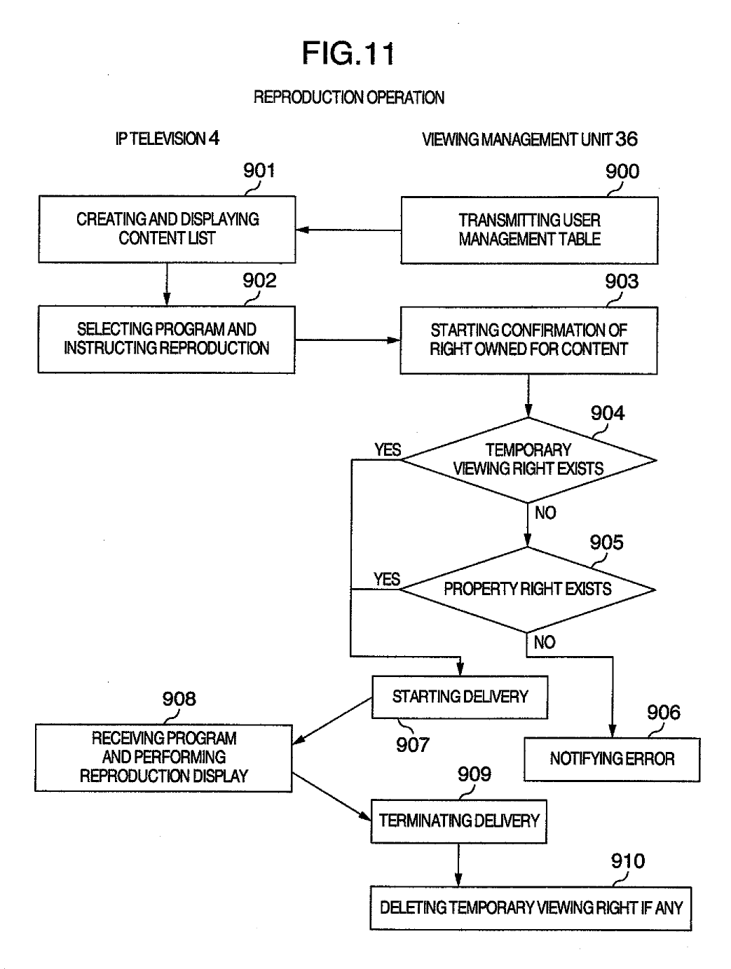

FIG. 11 is an explanatory diagram for illustrating a reproduction operation. Using sequence numbers starting from 900, the explanation will be given below regarding the sequences of the reproduction operation performed by the IP television 4 and the viewing management unit 36 inside the storage/delivery server 3.

First, at 900, the viewing management unit 36 transmits the user management table 42. At 901, the IP television 4 acquires all the information on the content-ID numbers stored in the temporary viewing right pre-purchased information 53 and the property right pre-purchased information 54 inside the user management table 42. Moreover, the IP television 4 creates content list for indicating a list of the contents where all these pieces of information are enumerated, then displaying the content list on the display unit 22. Subsequently, at 902, the user of the IP television 4 selects a program on the content list.

At 903, in order to confirm the rights which the user owns for the content, the viewing management unit 36 reads out the content-ID numbers' group stored in the temporary viewing right pre-purchased information 53 and the property right pre-purchased information 54 of the user management table 42. Subsequently, at 904, the unit 36 confirms whether or not the ID of the program, which is supposed to be reproduced at present, coincides with an ID stored in the table of the temporary viewing right pre-purchased information 53. Otherwise, at 905, the unit 36 confirms whether or not the ID of the program coincides with an ID stored in the table of the property right pre-purchased information 54. Then, if the unit 36 judges that either of the rights exists, the unit 36 starts delivery of the program at 907.

Meanwhile, if the IDs do not coincide with each other, and thus if the unit 36 judges that no right exists, the unit 36 proceeds to 906. At 906, the unit 36 notifies the IP television 4 of a notice to the effect that no right exists. (Incidentally, although no detailed explanation has been given regarding the error display method, the error is displayed on the IP television 4 to notify the user of the error.) At 908, the IP television 4 receives the program delivered, then performing the reproduction display.

After that, when the viewing by the reproduction is terminated, the viewing management unit 36 performs a delivery termination processing at 904, then transferring to 910. At 910, if the ID of the content whose delivery has been terminated is the ID included in the temporary viewing right pre-purchased information 53, i.e., if the viewing is the one using the temporary viewing right, the viewing management unit 36 judges that the temporary viewing right is terminated. Accordingly, the viewing management unit 36 deletes the content ID from the region of the temporary viewing right pre-purchased information 53 in the user management table 42 illustrated in FIG. 4.

As a consequence of the above-described operation, there exists an effect that the user of the IP television 4 may perform the reproduction viewing of the content which has the viewing right or the property right. In the present embodiment, the user of the IP television 4 is not required to store the contents at his or her own house. Consequently, the reproduction of the contents is always guaranteed, as long as the user continues to pay the archive usage fee 13 explained in FIG. 1 to an enterprise which manages the storage/delivery server 3. As a result, in comparison with the already-existing television broadcast system, there exists an effect that consumption of video-recording media such as video tape and DVD becomes unnecessary, and thus makes a contribution to implementation of the energy-saving.

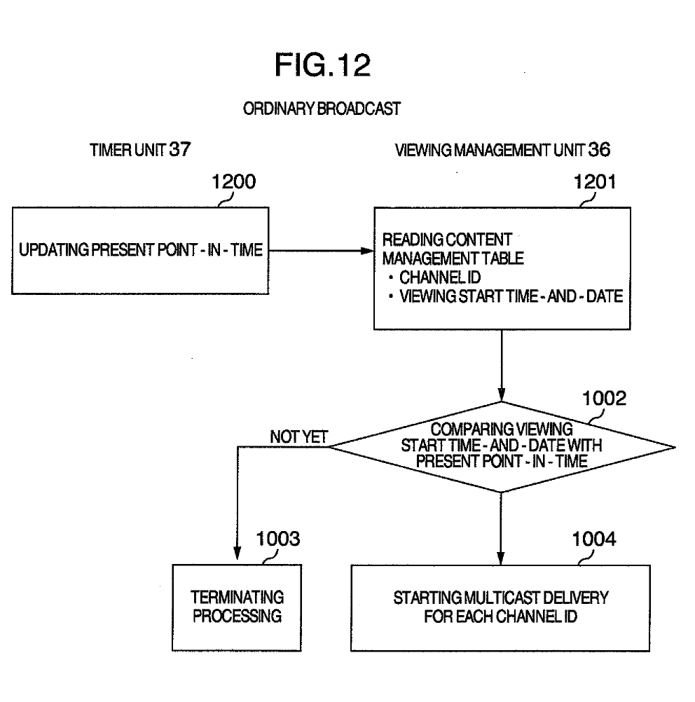

FIG. 12 is an explanatory diagram for illustrating sequences of the ordinary broadcast. Using sequence numbers starting from 1200, the explanation will be given below concerning the sequences of the ordinary broadcast performed by the timer unit 37 and the viewing management unit 36 inside the storage/delivery server 3. First, at 1200, the timer unit 37 updates the present point-in-time, then notifying the viewing management unit 36 of the present point-in-time updated. At 1201, the viewing management unit 36 carries out the reading of the content management table 41 illustrated in FIG. 4, thereby confirming the descriptions of the channel ID 47 and the viewing start time-and-date 49.

Subsequently, at 1202, the viewing management unit 36 makes a comparison between the present point-in-time notified from the timer unit 37 and the viewing start time-and-date 49. Then, if the present point-in-time has not attained to the viewing start time-and-date 49 yet, the unit 36 proceeds to 1203, then terminating the processing. Meanwhile, if the present point-in-time has attained to the time-and-date 49, the unit 36 proceeds to 1204. At 1204, the unit 36 carries out a multicast delivery which is allocated for each channel ID 47, then performing the delivery from the delivery unit 34 illustrated in FIG. 3.

Here, if, although no detailed description has been given, the channel ID 47 is the channel 0 whose ID is all “0”s, the content is a sales-specific content. Accordingly, no delivery is carried out. According to the present embodiment, there exists an effect that the television broadcast by the storage/delivery server 3 may be implemented.

In the present embodiment, no detailed description has been given concerning the so-called live broadcast. In the case of the live broadcast, even if the present point-in-time has attained to the broadcast start point-in-time, the whole content is not sent from the content-right holder 2 to the storage/delivery server 3 in FIG. 1. Instead, the content is sent little by little with a lapse of time. In that case, the in-advance viewing of a future program explained in FIG. 6 may not be implemented. Also, the in-advance purchase of a future program explained in FIG. 7 may not be implemented.

However, the reservation video-recording of a future program explained in FIG. 8 and FIG. 9 may be implemented. In the reproduction operation in FIG. 11, the delivery may be implemented from the storage/delivery server 3. This implementation is established if, before the start of the delivery at 907, the broadcast of the program had been terminated, or if only a little bit information capable of being delivered had arrived.

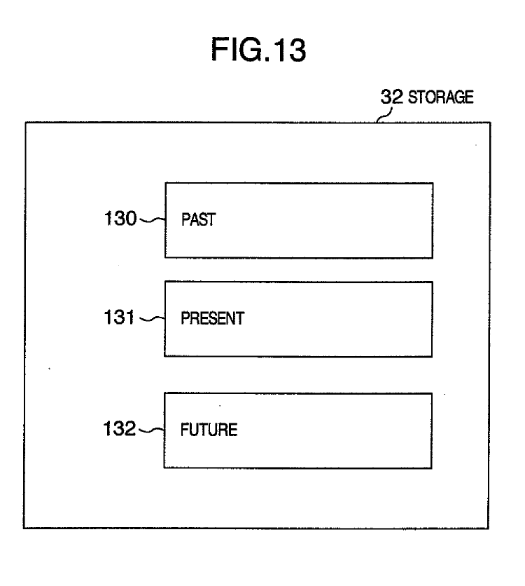

FIG. 13 is an explanatory diagram for illustrating another embodiment of the usage method for the storage. The reference numerals denote the following regions, respectively: 130 past region, 131 present region, and 132 future region. Although, in FIG. 13, the storage 32 is the same as the storage explained in FIG. 2 and FIG. 3, what differs therefrom is storage destinations for the contents 40. Namely, the regions of the past 130, the present 131, and the future 132 exist in the storage 32 illustrated in FIG. 13.

At the time of explaining the tense 51 in the content management table 41 illustrated in FIG. 4 given earlier, the following explanation has been given: The tense 51, which describes therein the flag for past, present, or future, indicates whether the corresponding content 40 is a past program, or a present program which is being broadcasted at present, or a future program which has not been broadcasted yet.

In FIG. 13, unlike this explanation, if the present point-in-time has become the broadcast start point-in-time, each content is displaced from the future 132 to the present 131. Also, if the broadcast is terminated, each content is displaced from the present 131 to the past 130. These displacements are performed so that each content will exist in its own region, i.e., the past 130, the present 131, or the future 132. Of course, although it is possible to manage each content without displacing its actual entity, each content is physically displaced deliberately on purpose. As a result, the more time elapses, the more the past programs increase continuously. Accordingly, there exists an effect that preparing a displacement-implementing unit is an advisable measure.

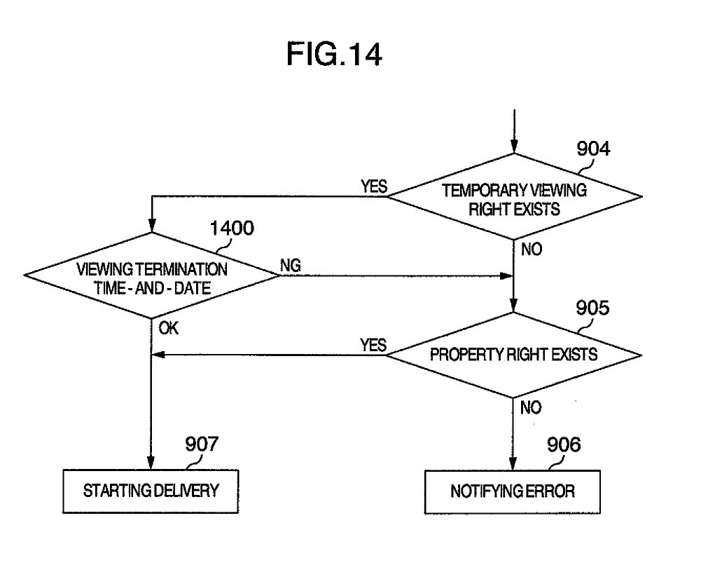

FIG. 14 is an explanatory diagram for illustrating an operation flow implemented at the time of adding a processing for the relationship between the viewing start time-and-date and viewing termination time-and-date, and the viewing rights. In FIG. 4 explained earlier, the explanation has been given regarding the content management table 41 and the user management table 42. Also, in FIG. 11 explained earlier, the explanation has been given regarding the reproduction processing in correspondence with the property right of the content at the time of the reproduction operation. In FIG. 14, however, a conditional branch 1400 is added to the operation flow at 904 and 905 illustrated in FIG. 11. This added conditional branch indicates another example of the management operation about the viewing start time-and-date 49 and the viewing termination time-and-date 50 in the content management table 41 and the viewing rights of the temporary viewing right pre-purchased information 53 and the property right pre-purchased information 54 in the user management table 42.

When the viewing is started, at 904 in FIG. 14, the viewing management unit 36 confirms whether or not the temporary viewing right exists. This means that it is confirmed whether or not the ID of the content whose viewing is started has been described in the region of the temporary viewing right pre-purchased information 53 of the user management table 42 in FIG. 4. If the temporary viewing right does not exist, the unit 36 proceeds to 905. Meanwhile, if the temporary viewing right exists, the unit 36 proceeds to the processing at 1400. At 1400, the unit 36 makes a comparison between the viewing termination time-and-date 50 of the content management table 41 in FIG. 4 and the present point-in-time at which the viewing is started.

If the present point-in-time is before the viewing termination time-and-date, no problem exists, and thus the judgment turns out to be OK. Accordingly, the unit 36 starts the delivery of the program at 907. Meanwhile, if the present point-in-time is after the viewing termination time-and-date, the problem exists, and thus the judgment turns out to be NG. Consequently, the unit 36 proceeds to 905. At 905, the unit 36 confirms whether or not the property right exists. This means that it is confirmed whether or not the ID of the content whose viewing is started has been described in the region of the property right pre-purchased information 54 of the user management table 42 in FIG. 4. If the ID has been described therein, the unit 36 judges that the property right exists. Accordingly, the unit 36 proceeds to 907, then starting the delivery. Meanwhile, if ID has been not described therein, the unit 36 judges that no property right exists. Consequently, the unit 36 proceeds to 906, then notifying the error.

As a consequence of the above-described operation, the following management-operation form may be implemented: Even if the user had purchased the temporary viewing right, the viewing is prohibited if the present point-in-time is past the viewing termination time-and-date. For example, as a management operation in the case where the broadcast right of content becomes invalid, this management operation may be implemented by setting the final time-and-date of a broadcast-capable time-period as being the viewing termination time-and-date. Conversely, a management operation which matches the price of the temporary viewing right may be implemented by lengthening the viewing termination time-and-date sufficiently. Also, if the property right has been pre-purchased, a management operation may be implemented where the viewing may be implemented even if the present point-in-time is past the viewing termination time-and-date.

Here, there exists an effect that, even in the case of a publication-terminated content which cannot be newly broadcasted due to a reason such that the broadcast right is eliminated by the content-right holder, the user who has purchased the property right may view the content at any time.

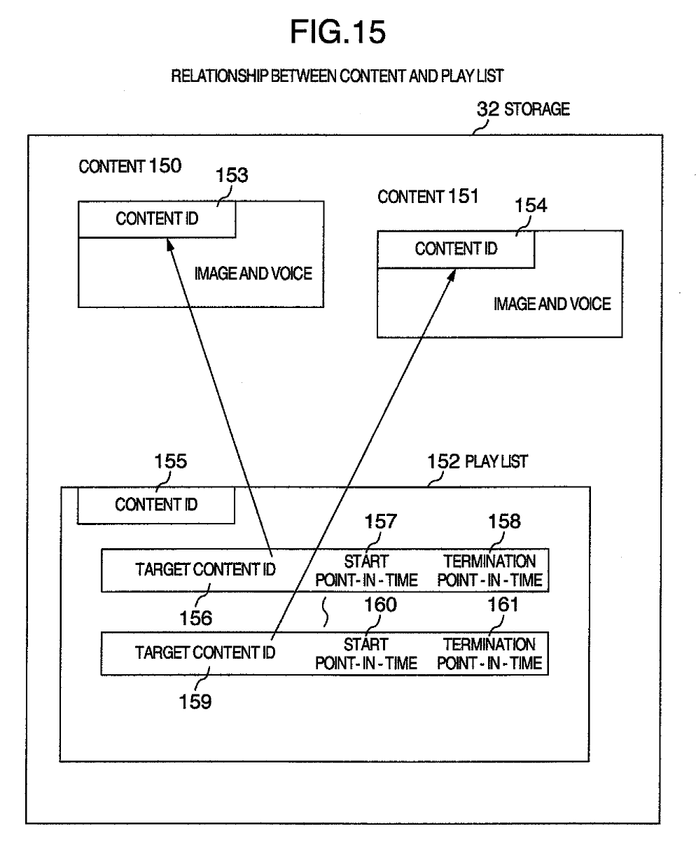

FIG. 15 is an explanatory diagram for illustrating the relationship between content and a play list. Here, the reference numerals denote the following information, respectively: 150 content, 151 content, 152 play list, 153 content ID, 154 content ID, 155 content ID, 156 target content ID, 157 start point-in-time, 158 termination point-in-time, 159 target content ID, 160 start point-in-time, and 161 termination point-in-time. In FIG. 15, the content 150 and the content 151 are stored into the storage 32 inside the storage/delivery server 3, and the play list 152 is stored therein newly.

The content ID 153 and the content ID 154 are affixed to the content 150 and the content 151, respectively. This is the same situation as that of the content 40 explained in FIG. 4. Being similar to the other contents, the content ID 155 is affixed to the play list 152. What is stored inside the play list 152, however, is not image and voice, but is a piece or a plural pieces of information including the target content ID 156, the start point-in-time 157, and the termination point-in-time 158. The number of the corresponding content ID is written as the target into this target content ID 156. In the present embodiment, the value stored into the content ID 153 of the content 150 is written there.

The start point-in-time 157 and the termination point-in-time 158 are information for meaning from where to where should be reproduced out of the target content. The information on the side of the target content ID 159 is basically the same. Accordingly, it turns out that the play list 152 indicates from the specified start point-in-time to the specified termination point-in-time should be sequentially reproduced out of the image and voice of the target content 150 and those of the target content 151 respectively. As a consequence, there exists an effect that the contents which are edited based on the concept of the play list may be stored into the storage/delivery server 3 and delivered therefrom.

At 904 and 905 in FIG. 11, before the start of the delivery, it has been confirmed by the viewing management unit 36 whether or not the viewing right or property right exists. Otherwise, at 1400 in FIG. 14, before the start of the delivery, it has been confirmed by the viewing management unit 36 whether or not the present point-in-time is past the viewing termination time-and-date. Similarly, it turns out that, as a method for reproducing the play list 152 when the user selects the content, the confirmation is carried out by the viewing management unit 36 whether or not the viewing right or property right of the target content ID 156 or the target content ID 159 has been acquired respectively in accordance with the description inside the play list 152 as was explained in FIG. 11 or FIG. 14.

The present embodiment indicates the state at the time when a plurality of contents are edited as the play list. Even in the case of the edited state, making reference to the copyright holder ID 46 of the content management table 41 in FIG. 4 permits the user to know who's writings the edited contents are. As a result, there exists the following effect: The delivery service fee 14, the archive usage fee 13, or the content purchase expense 15, which are paid by the user and was explained in FIG. 1, may be distributed to the content-right holder 2 as the sales profit 10.

Although no detailed explanation has been given concerning the creation method for the play list 152 illustrated in FIG. 15, this is not the file of a difficult structure. Consequently, it is advisable enough to be equipped with a function for creating a file by the user operation in which descriptions indicating from where to where should be reproduced are given sequentially. This creation of the file is performed via implementation units such as a content-ID acquisition unit, a reproduction unit specifying the content ID and the start point-in-time, a halt unit, and an acquisition unit for the present point-in-time during the reproduction.

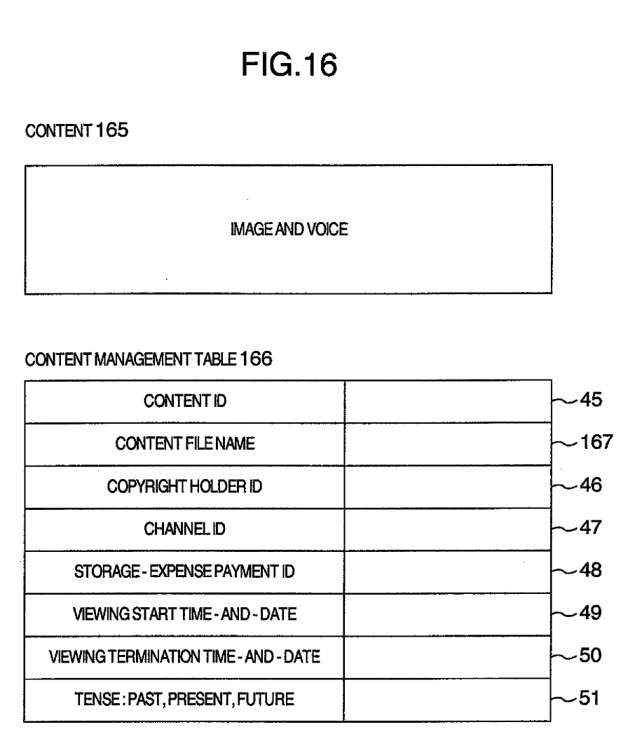

FIG. 16 is an explanatory diagram for illustrating another embodiment in the relationship between the content and the content management table explained in FIG. 4.

Here, the reference numerals denote the following information, respectively: 165 content, 166 content management table, and 167 content file name. The other information are the same as those explained in FIG. 4.

In FIG. 16, unlike the content 40 illustrated in FIG. 4, the content ID 43 is not affixed to the content 165. Instead, a region of the content file name 167 is newly added to the content management table 166. The content file name 167 is the file name on the storage inside the storage/delivery server 3, and is unique. In this embodiment, when making reference to the content, reference is made to the content ID 45 of the content management table 166 first, and subsequently, reference is made to the content file name 167.

After that, in order to indicate the content, the content 165 is searched for from the content file name 167, then making reference to the content 165. In this embodiment, there exists an effect that, when specifying the ID which is unique for each content, the uniqueness of each content provided from the content-right holder 2 may completely be maintained without changing each content itself.

Incidentally, in the relationship between the content and the play list explained in FIG. 15, reference has directly been made to the contents from the play list 152 in FIG. 15. In the embodiment explained using FIG. 16, however, reference is made to the content management table from the play list, and then, reference is made to the contents.

The objects to be accomplished by the above-described embodiments are as follows:

There is provided a service for permitting the content-right holder to acquire the advertisement expense and the sales profit as was exactly permitted conventionally.

Also, there is provided a system for preventing the contents from leaking out onto the Internet.

Also, when a plurality of programs are edited, whereabouts of the right becomes indefinite and unclear. There is provided a service for solving this problem.

There is provided a service for permitting a suitable processing for content to which the broadcast time-period is set from the portrait right or the like.

Also, there is provided a function for permitting the user to view and acquire a past program at any time.

There is provided a function for permitting the user to view and acquire a future program which has not been broadcasted yet.

Also, there is provided a system for permitting the user to make a contribution to the energy-saving without newly purchasing a medium for storing the contents.

The above-described embodiments permit implementation of the following effects:

There are provided a function and a service for permitting the video-recording to be implemented free of charge as was permitted conventionally. Even if the content-right holder has terminated the publication, the user may view the content at any time, as long as the content is addressed as being pre-video-recorded.

There exists an effect that the content-right holder may take advantage of the business model for permitting the content-right holder to acquire the advertisement expense and the sales profit as was exactly permitted conventionally.

Also, the contents are made available at any time not by storing the contents on the IP-television side, but by storing the contents into the storage/delivery server in a concentrated manner so that the contents will not leak out onto the Internet. Accordingly, there exists an effect that the leak-out itself is made meaningless.

Also, even in the case of edited programs, it is made distinguishable who is the right holder by tracing the right holder from the play list. Consequently, there exists an effect that the whereabouts of the right is made definite and clear.

Also, a unit for setting the broadcast time-period is prepared. As a result, there exists an effect that various right forms may be processed and addressed.

Also, all the programs (i.e., not only the past ones but also the future ones) exist in the storage/delivery server. Accordingly, there exists an effect that the user may view and acquire all the programs at any time.

Also, storing the contents is unnecessary from the beginning essentially. Consequently, there exists an effect that the user may make a contribution to the energy-saving without newly purchasing a medium.

It should be further understood by those skilled in the art that although the foregoing description has been made on embodiments of the invention, the invention is not limited thereto and various changes and modifications may be made without departing from the spirit of the invention and the scope of the appended claims.

1. A content delivery server, comprising:
a reception unit for receiving contents from a content supply server;
a memory unit for storing said received contents;
a viewing management unit for managing said contents and content IDs corresponding to said contents; and
a delivery unit for receiving a content ID from a user terminal, and delivering, to said user terminal, said content corresponding to said content ID.

2. The content delivery server according to claim 1, further comprising:
user management information including property-right purchase information for indicating whether or not said content is purchased by said user,
said viewing management unit recording said content ID corresponding to said content into said property-right purchase information included in said user management information, if said viewing management unit accepts a purchase request for said content from said user terminal.

3. The content delivery server according to claim 2, wherein
said viewing management unit accepts collection of a content storage fee from said user terminal, if said content ID is recorded in said property-right purchase information included in said user management information.

4. The content delivery server according to claim 2, wherein
said viewing management unit confirms whether or not said content ID is recorded in said property-right purchase information included in said user management information, said content ID being received from said user terminal,
said delivery unit delivering said content corresponding to said content ID to said user terminal, if said content ID is recorded in said property-right purchase information.

5. The content delivery server according to claim 2, wherein
said user management information further includes property-right reservation information which is used for reserving said purchase of said content,
said viewing management unit recording said content ID corresponding to said content into said property-right reservation information, if said viewing management unit accepts a reservation request for said content from said user terminal,
said viewing management unit deleting said content ID from said property-right reservation information, and recording said content ID into said property-right purchase information, if said reserved content is received from said content supply server.

6. The content delivery server according to claim 1, wherein
said viewing management unit displays information on an electronic program guide, if said content is received from said content supply server, said information indicating that said content has been pre-received.

7. The content delivery server according to claim 1, further comprising:
content management information including copyright information on said content,
said viewing management unit confirming whether or not copyright protection is specified for said content corresponding to said content ID by said copyright information, said content ID being received from said user terminal,
said delivery unit delivering said content corresponding to said content ID to said user terminal, if said copyright protection is not specified for said content.

8. A method of delivering content, comprising the steps of:
receiving contents from a content supply server;
maintaining said received contents into a memory unit; and
receiving a content ID from a user terminal, and delivering, to said user terminal, said content corresponding to said content ID.

9. The method of delivering content according to claim 8, further comprising the steps of:
maintaining user management information including property-right purchase information for indicating whether or not said content is purchased by said user; and
recording said content ID corresponding to said content into said property-right purchase information included in said user management information, if a purchase request for said content is accepted from said user terminal.

10. The method of delivering content according to claim 9, further comprising a step of:
accepting collection of a content storage fee from said user terminal, if said content ID is recorded in said property-right purchase information included in said user management information.

11. The method of delivering content according to claim 9, further comprising the steps of:
confirming whether or not said content ID is recorded in said property-right purchase information included in said user management information, said content ID being received from said user terminal; and
delivering said content corresponding to said content ID to said user terminal, if said content ID is recorded in said property-right purchase information.

12. The method of delivering content according to claim 9, wherein
said user management information further includes property-right reservation information which is used for reserving said purchase of said content,
said method, further comprising the steps of:
recording said content ID corresponding to said content into said property-right reservation information, if a reservation request for said content is accepted from said user terminal; and
deleting said content ID from said property-right reservation information, and recording said content ID into said property-right purchase information, if said reserved content is received from said content supply server.

13. The method of delivering content according to claim 8, further comprising a step of:
displaying information on an electronic program listing, if said content is received from said content supply server, said information indicating that said content has been pre-received.

14. The method of delivering content according to claim 8, further comprising the steps of:
maintaining content management information including copyright information on said content;
confirming whether or not copyright protection is specified for said content corresponding to said content ID by said copyright information, said content ID being received from said user terminal; and
delivering said content corresponding to said content ID to said user terminal, if said copyright protection is not specified for said content.
